(19) United States
(12) Patent Application Publication
(10) Pub. No.: US 2024/0084759 A1
(43) Pub. Date: Mar. 14, 2024

(54) CYLINDER HEAD

(71) Applicant: TOYOTA JIDOSHA KABUSHIKI KAISHA, Aichi-ken (JP)

(72) Inventor: Tomoya OSHIMA, Susono-shi (JP)

(21) Appl. No.: 18/449,709

(22) Filed: Aug. 15, 2023

(30) Foreign Application Priority Data
Sep. 14, 2022 (JP) 2022-146203

(51) Int. Cl. F02F 1/40

(52) U.S. Cl. CPC F02F 1/40

(57) ABSTRACT

A cylinder head includes an attachment member, the attachment member being spaced away from a first communication hole when the attachment member is attached to a first attachment hole of a first cylinder head main body, and a second cylinder head main body including a second partition wall portion separating two second water jackets, a second communication hole formed in the second partition wall portion and communicating the two second water jackets with each other, a second facing wall portion facing the second partition wall portion, and a second attachment hole formed in the second facing wall portion, wherein a distal end of the attachment member attached to the second attachment hole is inserted into the second communication hole.

### CROSS-REFERENCE TO RELATED APPLICATION

This application is based upon and claims the benefit of priority of the prior Japanese Patent Application No. 2022-146203, filed on Sep. 14, 2022, the entire contents of which are incorporated herein by reference.

### TECHNICAL FIELD

The present disclosure relates to a control device for a cylinder head.

### BACKGROUND

Two water jackets communicating with each other via a communication hole are formed in a cylinder head main body. There is also known a cylinder head in which a bolt is attached to an attachment hole formed in a cylinder head main body. A distal end of the bolt attached to the attachment hole is inserted into the communication hole, and the flow rate of the coolant flowing between the two water jackets is suppressed (see, for example, Japanese Unexamined Patent Application Publication No. 2010-216338).

Here, depending on the model, there is a case where the flow rate of the coolant flowing between the two water jackets is required. When the flow rate is required, it is conceivable that a bolt shorter than the above-described bolt is attached to the attachment hole and a distal end of the bolt is spaced away from the communication hole. When the bolts to be attached to the cylinder head main body are different depending on the model, it is needed to prepare bolts of different types. This might increase the manufacturing cost. In addition, for example, in a case where such a plurality of types of cylinder heads are manufactured in the same manufacturing line, the management cost might increase because the bolts are managed for each type. This may also increase the manufacturing cost.

### SUMMARY

It is therefore an object of the present disclosure to provide a cylinder head with reduced manufacturing cost.

The above object is achieved by a cylinder head including: an attachment member, the attachment member being spaced away from a first communication hole when the attachment member is attached to a first attachment hole of a first cylinder head main body, the first cylinder head main body including a first partition wall portion separating two first water jackets, the first communication hole formed in the first partition wall portion and communicating the two first water jackets with each other, a first facing wall portion facing the first partition wall portion, and the first attachment hole formed in the first facing wall portion; and a second cylinder head main body including a second partition wall portion separating two second water jackets, a second communication hole formed in the second partition wall portion and communicating the two second water jackets with each other, a second facing wall portion facing the second partition wall portion, and a second attachment hole formed in the second facing wall portion, wherein a distal end of the attachment member attached to the second attachment hole is inserted into the second communication hole.

The first partition wall portion may include a base portion formed into a flat shape, the first communication hole may penetrate through the first base portion, the second partition wall portion may include a second base portion formed into a flat shape, and a protruding portion protruding from the second base portion toward the second attachment hole, and the second communication hole may penetrate through the second base portion and the protruding portion.

### BRIEF DESCRIPTION OF THE DRAWINGS

FIG. 1 is an explanatory view of a first cylinder head; and

FIG. 2 is an explanatory view of a second cylinder head.

### DETAILED DESCRIPTION

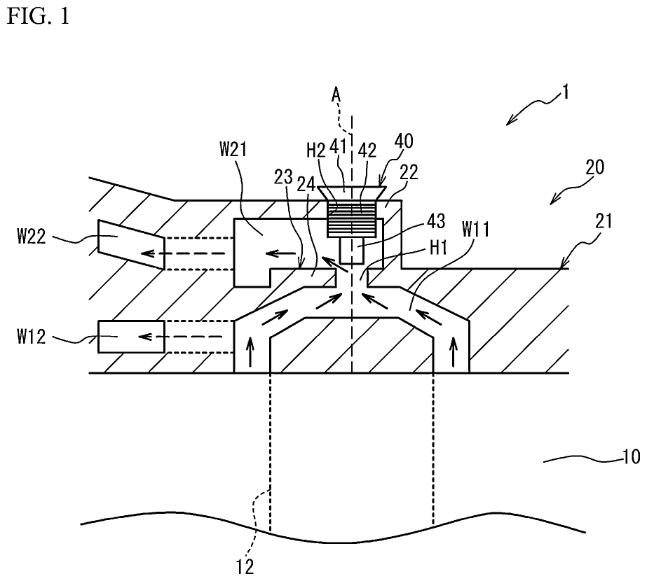

FIG. 1 is an explanatory view of a first cylinder head 20. FIG. 1 illustrates a partial cross section of the first cylinder head 20 in a direction orthogonal to a longitudinal direction of an engine 1 in which a plurality of cylinders 12 are arranged in the longitudinal direction. The engine 1 includes a cylinder block 10 and the first cylinder head 20. FIG. 1 illustrates the external appearance of the cylinder block 10. The first cylinder head 20 includes a first cylinder head main body 21 and a bolt 40. The first cylinder head main body 21 is fixed to the upper surface of the cylinder block 10.

Water jackets W11, W12, W21, and W22 through which coolant flows are formed in the first cylinder head main body 21. The water jacket W11 communicates with the water jacket of the cylinder block 10. The water jacket W12 is located on a side of the water jacket W11 and communicates with the water jacket W11. The water jacket W21 is located above the water jacket W11 and communicates with the water jacket W11. The water jacket W22 is located on a side of the water jacket W21 and communicates with the water jacket W21. The water jackets W11 and W21 are an example of first water jackets.

The coolant circulating in the engine 1 by a water pump flows from the cylinder block 10 side to the water jacket W11. A part of the coolant flowing to the water jacket W11 flows to the water jacket W12, and the other part flows to the water jacket W21. The coolant flowing to the water jacket W21 flows to the water jacket W22. The water jackets W11, W12, W21, and W22 are integrally formed with a core disposed in a casting mold when the first cylinder head main body 21 is cast.

A first partition wall portion 23 is formed between the water jacket W11 and the water jacket W21. The first partition wall portion 23 includes a base portion 24 formed into a flat shape. A first communication hole H1 is formed in the base portion 24. The water jacket W11 and the water jacket W21 communicate with each other via the first communication hole H1. A attachment hole H2 is formed in an upper wall portion 22 facing the first partition wall portion 23. The first communication hole H1 and the attachment hole H2 are coaxially provided on an axis A. The first communication hole H1 and the attachment hole H2 are used for discharging a core used at the time of casting the first cylinder head main body 21 and for venting gas. The base portion 24 is an example of a first base portion. The upper wall portion 22 is an example of a first facing wall portion. The attachment hole H2 is an example of a first attachment hole.

For example, a metal bolt 40 is attached to the attachment hole H2. The bolt includes a head portion 41, a large-diameter portion 42, and a small diameter portion 43. The head portion 41 is located at a proximal end of the bolt 40. The small-diameter portion 43 is located at a distal end of the bolt 40. The large-diameter portion 42 has an outer diameter smaller than that of the head portion 41. The small-diameter portion 43 has an outer diameter smaller than that of the large-diameter portion 42. A male screw portion is formed on an outer peripheral surface of the large-diameter portion 42. A female screw portion is formed on an inner peripheral surface of the attachment hole H2. The male screw portion of the large-diameter portion 42 and the female screw portion of the attachment hole H2 are screwed together. Thus, the bolt 40 is attached to the first cylinder head main body 21. The bolt 40 is an example of an attachment member.

The first cylinder head 20 is used when it is required to ensure the flow rate of the coolant flowing from the water jacket W11 to the water jacket W21. Securing such a flow rate of the coolant is required, for example, when it is desired to secure the cooling performance of the entire of the first cylinder head 20. Therefore, the bolt 40 attached to the attachment hole H2 faces the first communication hole H1, but is spaced away from the first communication hole H1. In other words, the distal end of the small-diameter portion 43 of the bolt 40 is spaced away from a region surrounded by the inner peripheral surface of the first communication hole H1. Therefore, the bolt does not obstruct the flow of the coolant flowing through the first communication hole H1, and the flow rate of the coolant flowing from the water jacket W11 to the water jacket W21 is secured.

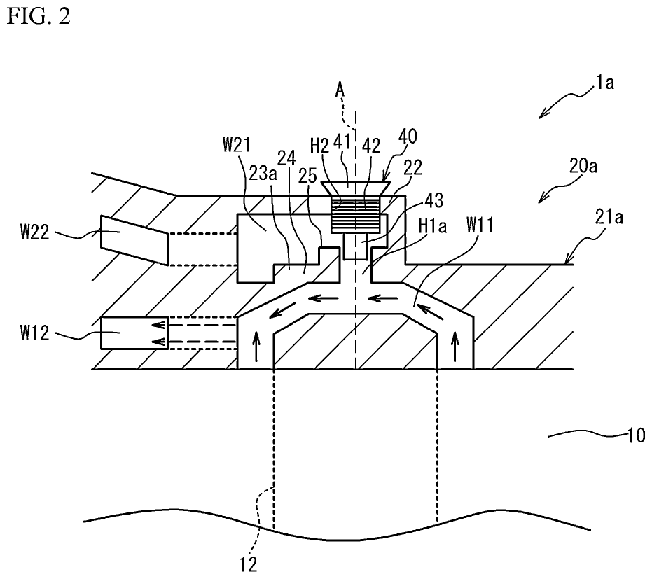

FIG. 2 is an explanatory view of a second cylinder head 20a. FIG. 2 corresponds to FIG. 1. The same components as those of the first cylinder head 20 are denoted by the same reference numerals, and redundant description thereof will be omitted. The same bolt 40 as the above-described bolt 40 is attached to a second cylinder head main body 21a of the second cylinder head 20a of an engine 1a. In the second cylinder head 20a, the water jacket W11 and the W21 separated by the second partition portion 23a are an example of a second water jacket. The base portion 24 is an example of a second base portion. The upper wall portion 22 is an example of a second facing wall portion. The attachment hole H2 is an example of a second attachment hole.

The second cylinder head 20a is used when it is required to suppress the flow rate of the coolant flowing from the water jacket W11 to the water jacket W21. Such suppression of the flow rate of the coolant is required, for example, when it is desired to efficiently cool a combustion chamber.

Unlike the first partition wall portion 23 of the first cylinder head main body 21 described above, the second partition wall portion 23a includes a protruding portion in addition to the base portion 24. The protruding portion 25 protrudes from the base portion 24 toward the attachment hole H2 side in an annular shape. A second communication hole H1a formed in the second partition wall portion 23a is formed so as to penetrate through the base portion 24 and the protruding portion 25. Therefore, the second communication hole H1a is longer than the first communication hole H1 in the direction of the axis A. Thus, the distal end of the small-diameter portion 43 of the bolt 40 is inserted into the second communication hole H1a. Here, an inside diameter of the second communication hole H1a is slightly larger than the outside diameter of the small-diameter portion 43. That is, there is a slight clearance between the second communication hole H1a and the small-diameter portion 43. Thus, in the second cylinder head 20a, the flow rate of the coolant from the water jacket W11 to the water jacket W21 is smaller than that in the first cylinder head 20. In the second cylinder head 20a, the flow rate of the coolant from the water jacket W11 to the water jacket W12 is larger than that in the first cylinder head 20. In this way, in the second cylinder head 20a, the flow rate of the coolant flowing from the water jacket W11 to the water jacket W21 is suppressed.

As described above, the same bolt 40 is used for the first cylinder head 20 in which the flow rate of the coolant flowing from the water jacket W11 to the water jacket W21 is required and for the second cylinder head 20a in which the flow rate is suppressed. Thus, an increase in the manufacturing cost of each of the first cylinder head 20 and the second cylinder head 20a is suppressed. Even when the first cylinder head 20 and the second cylinder head 20a, and the engines 1 and 1a are manufactured in the same manufacturing line, the bolt 40 can be commonly used. Therefore, it is possible to suppress an increase in management cost of the bolt 40.

In addition, due to the simple difference between the first partition wall portion 23 and the second partition wall portion 23a, it is possible to manufacture the first cylinder head main body 21 which is desired to be entirely cooled and the second cylinder head main body 21a which is desired to be cooled preferentially on the combustion chamber side. This also suppresses an increase in the manufacturing cost of each of the first cylinder head 20 and the second cylinder head 20a.

In the above-described embodiment, the bolt 40 is described as an example of the attachment member. However, the attachment member is not limited thereto and may be, for example, a screw.

In the engines 1 and 1a described above, the case where the cylinder block 10 is commonly used has been described as an example, but the embodiment is not limited thereto. The first cylinder head 20 and the second cylinder head 20a have the same configuration except for the first partition wall portion 23, the second partition wall portion 23a, the first communication hole H1, and the second communication hole H1a. However, the configuration is not limited thereto.

Although some embodiments of the present disclosure have been described in detail, the present disclosure is not limited to the specific embodiments but may be varied or changed within the scope of the present disclosure as claimed.

What is claimed is:

1. A cylinder head comprising:
an attachment member, the attachment member being spaced away from a first communication hole when the attachment member is attached to a first attachment hole of a first cylinder head main body, the first cylinder head main body including a first partition wall portion separating two first water jackets, the first communication hole formed in the first partition wall portion and communicating the two first water jackets with each other, a first facing wall portion facing the first partition wall portion, and the first attachment hole formed in the first facing wall portion; and
a second cylinder head main body including
a second partition wall portion separating two second water jackets,
a second communication hole formed in the second partition wall portion and communicating the two second water jackets with each other,
a second facing wall portion facing the second partition wall portion, and
a second attachment hole formed in the second facing wall portion,
wherein a distal end of the attachment member attached to the second attachment hole is inserted into the second communication hole.

2. The cylinder head according to claim 1, wherein
the first partition wall portion includes a base portion formed into a flat shape,
the first communication hole penetrates through the first base portion,
the second partition wall portion includes
a second base portion formed into a flat shape, and
a protruding portion protruding from the second base portion toward the second attachment hole, and
the second communication hole penetrates through the second base portion and the protruding portion.
